(19) United States
(12) Patent Application Publication
(10) Pub. No.: US 2026/0322595 A1
(43) Pub. Date: Oct. 15, 2026

(54) QUANTUM KEY DISTRIBUTION CALIBRATION SETUP AND METHOD THEREOF

(71) Applicant: ID QUANTIQUE SA, Genéve (CH)

(72) Inventors: Damien STUCKI, Geneve (CH); Gianluca BOSO, Petit-Lancy (CH)

(21) Appl. No.: 19/484,493

(22) PCT Filed: May 14, 2024
(86) PCT No.: PCT/EP2024/063245

§ 371 Date: Nov. 14, 2025

(30) Foreign Application Priority Data
May 16, 2023 (EP) 23173685.1

(51) Int. Cl. H04L 9/08

(52) U.S. Cl. CPC H04L 9/0852

(57) ABSTRACT

The present invention relates to Calibration system for calibrating a QKD emitter comprising said QKD emitter provided with a light source for generating light and an output connector for exiting the generated light, and a telecom characterization setup located at the output connector characterized in that the calibration system further comprises a pair of switchable connectors adapted to be switched between a first position where the connectors are exposed to the outside of the QKD emitter and a second position where the connectors are internally connected for providing a light path from the light source to the output connector, and an optical amplifier connected to the connectors switched in the first position for calibration procedure.

### TECHNICAL FIELD

The present invention relates to the field of calibration setups for quantum key distribution and more particularly to a device and a method for calibrating a quantum key distribution system. Even more particularly it relates to a device and a method for calibrating a quantum key distribution emitter.

### BACKGROUND OF THE ART

In recent years, quantum cryptography has been proven as being one the most reliable techniques in secure information exchange technology. Among the several techniques, Quantum Key Distribution has been shown to be one of the most promising. The primary goal of Quantum Key Distribution (QKD) is to be able to share between an emitter and a receiver a sequence of bits whose privacy can be proven with a limited set of assumptions.

Quantum Key Distribution (QKD) is a method allowing the distribution of a secret key between two distant parties, the emitter and the receiver, with a provable security. The two parties encode the key on elementary quantum systems, such as photons, which they exchange over a quantum channel, such as an optical fiber or a free space link. The security of this method comes from the well-known fact that the measurement of the quantum state of an unknown quantum system modifies the system itself. In other words, a spy eavesdropping on the quantum communication channel cannot get information on the key without introducing errors in the key exchanged between the emitter and the receiver. Equivalently, QKD is secure because of the no-cloning theorem of quantum mechanics, which ensures that a spy cannot duplicate the transmitted quantum system and forward a perfect copy to the receiver.

During the manufacturing of a QKD system, the transmitter or emitter (usually called Alice) needs to be tuned and characterized. One of the steps of this process is to tune and characterize the intensity, the temporal and spectral shape of the optical pulses generated by the laser placed inside Alice. In particular, the calibration aims at defining the parameters of the light signal outputted by Alice, such as wavelength, the number of photons per pulse po, the levels of decoy μ1 and μ2, and the FWHM of the output beam.

Hence, an important step is to characterize the light source, i.e. the current and the temperature of the laser as well as its wavelength, intensity levels, FWHM of the signal, phase modulation or the same, which is not possible without amplifying the signal of the laser in the correct way. In fact, given the typical losses of a QKD emitter, even without adding optical attenuators, the signal generated is too low to be measured by standard lab equipment

A skilled person in the art will try to plug standard equipment at the output of Alice to perform the calibration but due to such low signals he would not be able to perform any measurements. Even if he tries to add a commonly available optical amplifier at the output of Alice (with a typical amplification gain of 20-30 dB), this will add so much noise that the noise will be higher than the signal, and the calibration cannot be performed.

Therefore, it is known in the art to characterize the emitter with a single-photon detector (SPD) combined with either a TDC (time-to-digital converter) or a counter and other standard optical equipment such as fixed or tunable optical filters, couplers, interferometers etc. However, apart from the inconvenience that SPDs are non-standard equipment which are known only by few experts—hence not every skilled person in the art will know how to use them—the procedure is also slow as there is the need to integrate the signal for a long time before having a meaningful measurement. In addition, the results need to be interpreted not being real-time. Thus, resulting in a slow and not practical testing method.

Alternatively, the emitter is not calibrated at all, which means that only the single components of the emitter, which need mandatorily to be calibrated, are characterized but not the whole system. This is done with the use of the QKD receiver, but it transforms the calibration into a statistical analysis. Hence being slow and complex. In addition to the problem of the statistical analysis mentioned above, when one performs unit tests on the single components but not on the Alice Assembly, one discovers faulty Alice assemblies only when one tests the entire QKD system instead of during the fabrication of the Alice module.

In view of the above, one can see that the problem associated with the calibration performed with an SPD combined with a TDC is that it is slow and not practical, having only a few experts capable of using this non-standard equipment. Also, the problem associated with not testing the emitter as whole but by using the QKD receiver indeed transforms the calibration into a statistical analysis, hence being slow, and in addition devoted only to few components of the emitter preventing to measure possible failures in the emitter system.

There is therefore a need for such a solution for speeding up and simplifying the calibration of a QKD emitter.

In this regard, a primary object of the invention is to provide a device and a method for easily, rapidly, and reliably calibrating a quantum key distribution emitter.

### SUMMARY OF THE INVENTION

The above problems are solved by the present invention comprising an optical amplifier used in combination with a photodiode which is put at the output of Alice. This calibration setup is then preferably connected to a standard telecom characterization setup, consisting of either an oscilloscope (real-time or sampling) to perform timing and intensity measurements or an optical spectrum analyzer to perform wavelength measurements. Such calibration setup provides real-time response of the output of Alice, hence being faster as no time for integration is needed. In addition, such setup is easy to implement.

In this regards, a first aspect of the invention is a calibration system for calibrating a QKD emitter comprising the QKD emitter provided with a light source for generating light, an output connector for exiting the generated light, and at least one switchable connector, preferably a pair of them, adapted to be switched between a first position where the switchable connectors are exposed to the outside of the QKD emitter and a second position where the switchable connectors are internally connected for providing a light path from the light source to the output connector, characterized in that the calibration system further comprises an optical amplifier and a standard telecom characterization setup wherein the optical amplifier is connected to the connector in the first position and the standard telecom characterization setup is located at the output connector.

Preferably, the optical amplifier is an Erbium-Doped Fiber Amplifier (EDFA).

In addition, the standard telecom characterization setup comprises a photodiode and an acquisition system capable of reading the signal of the photodiode.

Preferably, the acquisition system is an oscilloscope for timing and intensity measurements or an optical spectrum analyzer for wavelength measurements.

Advantageously, the photodiode is an amplified photodiode.

According to a preferred embodiment of the present invention, the amplified photodiode is a high-speed photodiode with a bandwidth higher than 10 GHz.

In a preferred manner, the QKD emitter further comprises an encoder stage which includes modulation optics, passive optical components, and an attenuator.

Advantageously, the modulation optics comprises at least one active or passive modulation optics such as an intensity modulator and/or a phase modulator.

Optionally the optical attenuator is one of a variable and/or fixed attenuator.

According to a preferred embodiment of the present invention, the at least one switchable connector is disposed between the light source and the encoder stage

### BRIEF DESCRIPTION OF THE DRAWINGS

Further particular advantages and features of the invention will become more apparent from the following non-limitative description of at least one embodiment of the invention which will refer to the accompanying drawings, wherein

FIG. 1 represents a conventional QKD emitter,

FIG. 2 represents a calibration Setup for a standard QKD emitter,

FIGS. 3A and 3B represent a QKD emitter of the present invention,

FIG. 4 represents a calibration setup for a QKD emitter of the present invention.

### DETAILED DESCRIPTION OF THE INVENTION

The present detailed description is intended to illustrate the invention in a non-limitative manner since any feature of an embodiment may be combined with any other feature of a different embodiment in an advantageous manner.

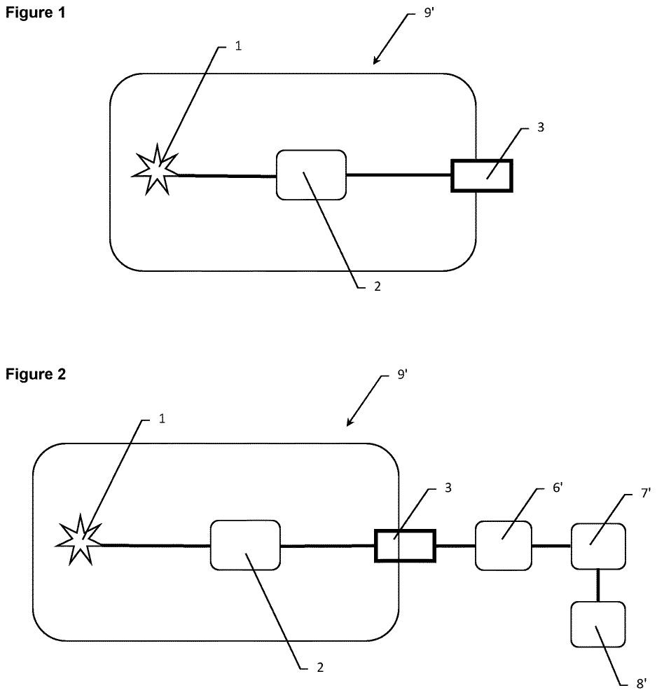

FIG. 1 shows a conventional QKD emitter which comprises a laser source 1, an encoder stage 2 and an output connector 3, wherein the encoder stage 2 preferably comprises among others at least one of modulation optics and an attenuator so as to be able to carry out the QKD protocol. In addition to that, FIG. 2 shows a conventional QKD emitter calibration setup using a single-photon detector (SPD) combined with a time-to-digital converter (TDC) connected to a computer.

As we can see, the standard QKD emitter does not give internal access to the light path and needs to be calibrated with a sensitive outside setup (SPD+TDC) giving rise to the drawbacks explained above.

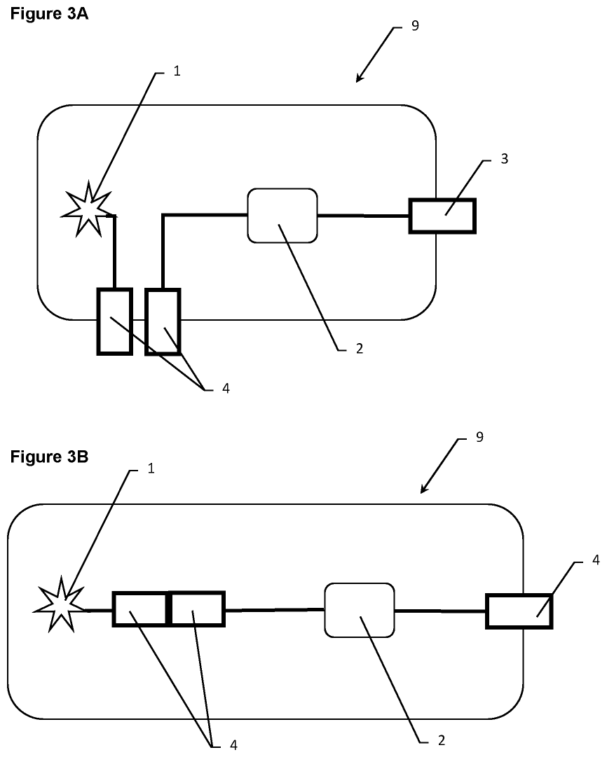

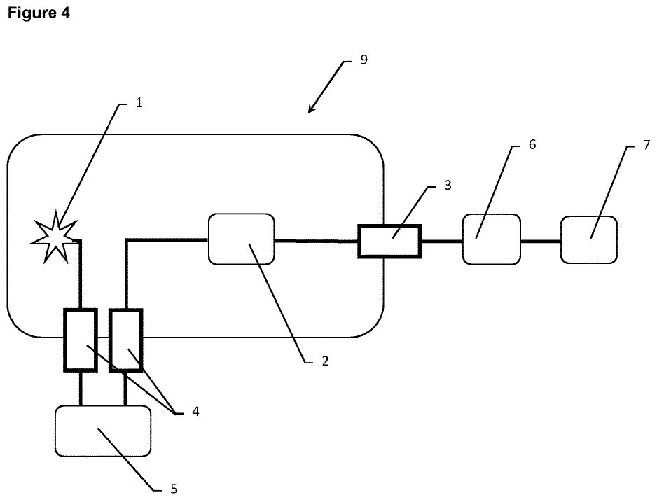

In order to solve these problems, the present invention is shown in FIGS. 3A, 3B and 4 schematically representing a QKD emitter also comprising a laser source 1, encoder stage 2 and an output connector 3 and is further provided with at least one, preferably an additional pair of, switchable connectors 4, between the laser source 1 and encoder stage 2.

The encoder stage may comprise either active or passive modulation optics such as an intensity modulator or a phase modulator. Furthermore, it may comprise passive optical components such as an optical filter, an interferometer, or a coupler. The encoder stage may also include a variable and/or fixed attenuator that serves to attenuate the signal down to single-photon level. The above list is not limitative as the list and the order of these components vary depending on the specific implementation and protocol.

This pair of switchable connectors 4 is adapted to be switched between two positions shown in FIGS. 3A and 3B, respectively. FIG. 3A shows the emitter 9 with the connector 4 in the first position where the connector 4 is exposed to the outside of the QKD emitter for calibration and FIG. 3B shows the emitter 9 with the connector 4 in the second position where the connector 4 is internally connected for normal operation.

While this is not represented in the figures, it has to be noted that an actuation system can be provided to automatize the connectors switch.

The QKD emitter 9 permits, thanks to the connector 4 to install an optical amplifier 6 between the laser source 1 and the encoder stage 2 during calibration, boosting the optical output power of the emitter 9 in order to use a standard telecom characterization setup made of a photodiode and an oscilloscope to measure the temporal or spectral shape of the light signal coming out of the emitter 9, as shown in FIG. 4 representing the calibration setup for a QKD emitter according to the present invention.

Given the low light levels in play, in some specific cases the photodiode is an amplified photodiode that can additionally boost the output signal. This is only required depending on the intrinsic losses of the QKD emitter.

Preferably, the bandwidth of the amplified photodiode is higher than 10 GHz. This permits to enhance the setup because the typical signals to be measured in a QKD system can be shorter than a few hundred picoseconds and so to measure them correctly such bandwidths are preferred. On the other hand, a lower-speed QKD system does not need such bandwidth.

With this calibration setup it is possible to provide an instrument (such as an oscilloscope or an optical spectrum analyzer) capable of reading the signal from the photodiode and that can be used to perform the calibration procedure. The typical calibration procedure of a QKD emitter consists in measuring the temporal and/or spectral shape of the light coming out of the emitter to measure different parameters like: FWHM of the pulses, shape of the pulses, intensity with time of the pulses, distance between the pulses, emission spectrum of the pulses and then calibrate the emitter in function of the results.

While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the scope of this disclosure. This for example is particularly the case regarding the different apparatuses which can be used.

### LIST OF REFERENCES

9 QKD Emitter
1 Laser source
2 Encoder stage
3 Output connector
4 Calibration connector
5 Amplifier
6 Photodiode
7 Oscilloscope
9′ Conventional QKD Emitter
6′ SPD
7′ TDC
8′ Computer

1. A calibration system for calibrating a QKD emitter (9) comprising
said QKD emitter (9) provided with a light source (1) for generating light and an output connector (3) for exiting the generated light, and
a telecom characterization setup (6, 7) located at the output connector (3), characterized in that the calibration system further comprises
at least one switchable connector (4) adapted to be switched between a first position where the switchable connector (4) is exposed to the outside of the QKD emitter (9) and a second position where the switchable connector (4) is internally connected for providing a light path from the light source (1) to the output connector (3), and
an optical amplifier (5) connected to the switchable connector (4) switched in the first position for calibration procedure.

2. The calibration system according to claim 1, characterized in that the optical amplifier (5) is an Erbium-Doped Fiber Amplifier (EDFA).

3. The calibration system according to claim 1 or claim 2, characterized in that the standard telecom characterization setup comprises a photodiode (6) and an acquisition system capable (7) to read the signal of the photodiode (6).

4. The calibration system according to claim 3, characterized in that the acquisition system is an oscilloscope (7).

5. Calibration system according to claim 3, characterized in that the acquisition system is an optical spectrum analyzer (7)

6. The calibration system according to claim 3, 4 or 5, characterized in that the photodiode (6) is an amplified photodiode.

7. The calibration system according to claim 6, characterized in that the amplified photodiode (6) is a high-speed photodiode with a bandwidth higher than 10 GHz.

8. The calibration system according to any one of claims 1 to 7, characterized in that the QKD emitter (7) further comprise an encoder stage (2).

9. The calibration system according to any one of claims 1 to 8, characterized in that the encoder stage (2) comprises at least one of active or passive modulation optics such as an intensity modulator and/or a phase modulator.

10. The calibration system according to any one of claims 1 to 8, characterized in that the encoder stage (2) comprises at least a fixed and/or variable optical attenuator.

11. The calibration system according to any one of claims 1 to 10, characterized in that the pair of switchable connectors (4) is disposed between the light source (1) and the encoder stage (2).

12. The calibration system according to any one of claims 1 to 11, characterized in that the at least one switchable connector comprises a pair of switchable connectors (4).
